(19) United States
(12) Patent Application Publication
(10) Pub. No.: US 2021/0319683 A1
(43) Pub. Date: Oct. 14, 2021

(54) REAL-TIME COMMUNICATION LINK WITH A CARGO HANDLING SYSTEM

(71) Applicant: GOODRICH CORPORATION, Charlotte, NC (US)

(72) Inventors: Zamira A. Daw Perez, Albany, CA (US); Alessandro Pinto, Kensington, CA (US); Richa Varma, Emeryville, CA (US); Olusegun T. Oshin, Middletown, CT (US)

(73) Assignee: GOODRICH CORPORATION, Charlotte, NC (US)

(21) Appl. No.: 17/221,966

(22) Filed: Apr. 5, 2021

Related U.S. Application Data
(60) Provisional application No. 63/009,776, filed on Apr. 14, 2020.

(51) Int. Cl. G08B 21/18; G06Q 10/08

(52) U.S. Cl. CPC G08B 21/18; G06Q 10/083

(57) ABSTRACT

A communication network configured for connection with a cargo handling system and a third party is disclosed. In various embodiments, the communication network includes a first processor; a first communication link connecting the first processor to the cargo handling system, the cargo handling system including a plurality of sensing agents configured to monitor a status of a cargo load; and a second communication link connecting the first processor to the third party, where the first processor is configured to receive a first load status data from the cargo handling system over the first communication link and to transmit a second load status data to the third party over the second communication link.

### CROSS-REFERENCE TO RELATED APPLICATIONS

This application claims priority to, and the benefit of, U.S. Provisional Patent Application No. 63/009,776, filed Apr. 14, 2020 and titled “REAL-TIME COMMUNICATION LINK WITH A CARGO HANDLING SYSTEM,” which application is incorporated herein by reference in its entirety for all purposes.

### FIELD

The present disclosure relates generally to cargo handling systems and, more particularly, to methods, apparatus and systems used to determine and communicate real-time or historical information concerning the status of cargo handling systems or the cargo being transported by such systems.

### BACKGROUND

Cargo handling systems for aircraft typically include various tracks and rollers disposed on a cargo deck that spans the length of a cargo compartment. Cargo may be loaded from an entrance of the aircraft and transported by the cargo system to forward or aft locations, depending upon the configuration of the aircraft. Cargo handling systems, such as, for example, those used on aircraft for transport of heavy containerized cargo or pallets, also referred to herein as unit load devices (ULDs), typically include roller trays containing transport rollers that support and transport the containerized cargo or pallets. Motor driven rollers are typically employed in these systems. In certain aircraft, a plurality of motor driven power drive units (PDUs) is used to propel the containers or pallets within the cargo compartment. This configuration facilitates transportation of the containers or pallets within the cargo compartment by one or more operators or agent-based systems controlling operation of the PDUs. Autonomous cargo handling systems generally include a plurality of multi-modal sensors in electronic communication with one another and configured to monitor or control operation of the systems. Systems and methods configured to detect and report on the real-time operational status of cargo handling systems configured for autonomous operation and the real-time conditions of the cargo being transported over such systems are advantageous both to owners and operators of the cargo handling systems and to the owners of the cargo being transported.

### SUMMARY

A communication network configured for connection with a cargo handling system and a third party is disclosed. In various embodiments, the communication network includes a first processor; a first communication link connecting the first processor to the cargo handling system, the cargo handling system including a plurality of sensing agents configured to monitor a status of a cargo load; and a second communication link connecting the first processor to the third party, where the first processor is configured to receive a first load status data from the cargo handling system over the first communication link and to transmit a second load status data to the third party over the second communication link.

In various embodiments, the first processor is configured to analyze the first load status data and to generate the second load status data. In various embodiments, the second load status data is representative of the status of the cargo load. In various embodiments, the status of the cargo load is a visual representation of the cargo load. In various embodiments, the status of the cargo load represents one or more of a pressure measurement, a temperature measurement or a humidity measurement within an aircraft envelope that surrounds the cargo load.

In various embodiments, the communication network further includes a second processor and a third communication link connecting the second processor to the cargo handling system, the second processor configured to receive a system status data from the cargo handling system. In various embodiments, the second processor is configured to analyze the system status data and to generate a system status signal that indicates a fault within the cargo handling system. In various embodiments, the second processor is configured to transmit a system update to the cargo handling system. In various embodiments, the second processor is configured to transmit the system update to the cargo handling system over the third communication link.

In various embodiments, the communication network further includes a fourth communication link configured to transmit control signals to the cargo handling system from an auxiliary control unit. In various embodiments, the auxiliary control unit is configured to receive the system status data over the fourth communication link. In various embodiments, the auxiliary control unit is configured to override a system controller configured to operate the cargo handling system.

A method of communicating information between a cargo handling system and a third party is disclosed. In various embodiments, the method includes connecting a first processor to the cargo handling system via a first communication link, the cargo handling system including a plurality of sensing agents configured to monitor a status of a cargo load; receiving a first load status data over the first communication link, the first load status data generated by the plurality of sensing agents; connecting the first processor to the third party via a second communication link; and transmitting a second load status data to the third party over the second communication link, the second load status data being representative of the status of the cargo load. In various embodiments, the method further includes analyzing the first load status data by the first processor to generate the second load status data.

In various embodiments, the status of the cargo load is a visual representation of the cargo load. In various embodiments, the status of the cargo load represents one or more of a pressure measurement, a temperature measurement or a humidity measurement within an aircraft envelope that surrounds the cargo load.

In various embodiments, the method includes connecting a second processor to the cargo handling system via a third communication link and receiving by the second processor a system status data from the cargo handling system. In various embodiments, the method includes analyzing the system status data and generating a system status signal in an event of a fault within the cargo handling system. In various embodiments, the method includes transmitting a system update over the third communication link to the cargo handling system. In various embodiments, the method includes transmitting a control signal over a fourth communication link to the cargo handling system from an auxiliary control unit and receiving the system status data over the fourth communication link.

The forgoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The accompanying drawings illustrate various embodiments employing the principles described herein and are a part of the specification. The illustrated embodiments are meant for description and not to limit the scope of the claims.

FIG. 1A illustrates a schematic view of an aircraft being loaded with cargo, in accordance with various embodiments;

FIG. 1B illustrates a top view of a cargo deck for the aircraft of FIG. 1A, in accordance with various embodiments;

FIG. 2 illustrates a top view of a cargo handling system, in accordance with various embodiments;

FIG. 3A illustrates a top view of a cargo handling system configured for autonomous operation, in accordance with various embodiments;

FIG. 3B illustrates a block diagram of a sensing agent for use in a cargo handling system configured for autonomous operation, in accordance with various embodiments;

FIG. 4 illustrates a communication network in operable connection with a cargo handling system configured for autonomous operation, in accordance with various embodiments; and

FIG. 5 describes a method of communicating information between a cargo handling system configured for autonomous operation and a third party.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

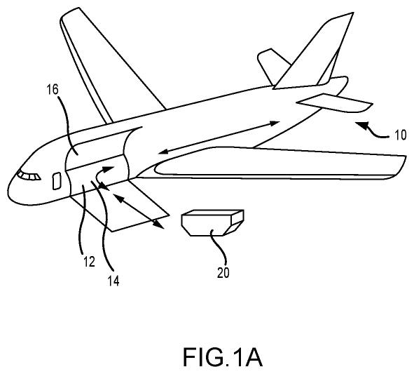

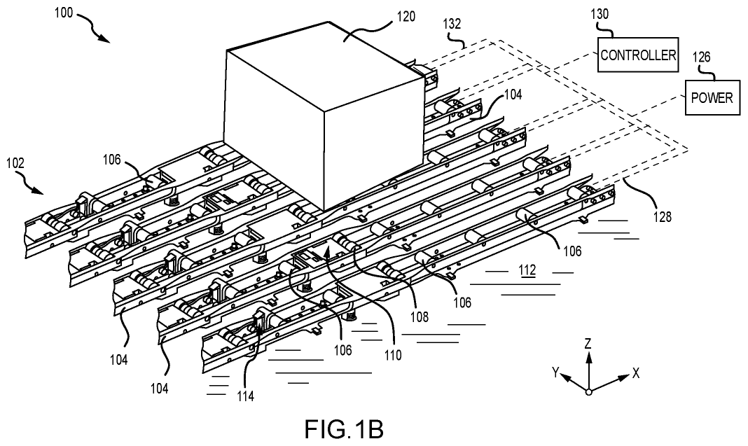

With reference to FIG. 1A, a schematic view of an aircraft 10 having a cargo deck 12 located within a cargo compartment 14 is illustrated, in accordance with various embodiments. The aircraft 10 may comprise a cargo load door 16 located, for example, at one side of a fuselage structure of the aircraft 10. A unit load device (ULD) 20, in the form of a container or a pallet, for example, may be loaded through the cargo load door 16 and onto the cargo deck 12 of the aircraft 10 or, conversely, unloaded from the cargo deck 12 of the aircraft 10. In general, ULDs are available in various sizes and capacities, while pallets are typically standardized in dimension and shape; the disclosure proceeds by referring generally to ULDs, though the disclosure is equally applicable to pallets and the various cargo placed thereon. Once loaded with items destined for shipment, the ULD 20 is transferred to the aircraft 10 and then loaded onto the aircraft 10 through the cargo load door 16 using a conveyor ramp, scissor lift or the like. Once inside the aircraft 10, the ULD 20 is moved within the cargo compartment 14 to a final stowed position. Multiple ULDs may be brought on-board the aircraft 10, with each ULD 20 being placed in a respective stowed position on the cargo deck 12. After the aircraft 10 has reached its destination, each ULD 20 is unloaded from the aircraft 10 in similar fashion, but in reverse sequence to the loading procedure. To facilitate movement of the ULD 20 along the cargo deck 12, the aircraft 10 may include a cargo handling system as described herein in accordance with various embodiments.

Referring now to FIG. 1B, a portion of a cargo handling system 100 is illustrated, in accordance with various embodiments. The cargo handling system 100 is illustrated with reference to an XYZ coordinate system, with the X-direction extending longitudinally aft and the Z-direction extending vertically with respect to an aircraft in which the cargo handling system 100 is positioned, such as, for example, the aircraft 10 described above with reference to FIG. 1A. In various embodiments, the cargo handling system 100 may define a conveyance surface 102 having a plurality of trays 104 supported by a cargo deck 112, such as, for example, the cargo deck 12 described above with reference to FIG. 1A. The plurality of trays 104 may be configured to support a unit load device (ULD) 120 (or a plurality of ULDs), such as, for example, the unit load device (ULD) 20 described above with reference to FIG. 1A. In various embodiments, the ULD 120 may comprise a container or a pallet configured to hold cargo as described above. In various embodiments, the plurality of trays 104 is disposed throughout the cargo deck 112 and may support a plurality of conveyance rollers 106, where one or more or all of the plurality of conveyance rollers 106 is a passive roller. In various embodiments, the conveyance surface 102 is a planar surface defined by the plurality of conveyance rollers 106.

In various embodiments, the cargo handling system 100 includes a plurality of power drive units (PDUs) 110, each of which may include one or more drive rollers 108 that may be actively powered by a motor. In various embodiments, one or more of the plurality of trays 104 is positioned longitudinally along the cargo deck 112—e.g., along the X-direction extending from the forward end to the aft end of the aircraft. In various embodiments, the plurality of conveyance rollers 106 and the one or more drive rollers 108 may be configured to facilitate transport of the ULD 120 in the forward and the aft directions along the conveyance surface 102. Similarly, one or more of the plurality of trays 104 is positioned laterally along the cargo deck 112—e.g., along the Y-direction extending from a starboard side to a port side of the aircraft—and the plurality of conveyance rollers 106 and the one or more drive rollers 108 may be configured to facilitate transport of the ULD 120 in the starboard and port directions along the conveyance surface 102. During loading and unloading, the ULD 120 may variously contact the one or more drive rollers 108 to provide a motive force for transporting the ULD 120 along the conveyance surface 102. Each of the plurality of PDUs 110 may include an actuator, such as, for example, an electrically operated motor, configured to drive the one or more drive rollers 108 corresponding with each such PDU. In various embodiments, the one or more drive rollers 108 may be raised from a lowered position beneath the conveyance surface 102 to an elevated position above the conveyance surface 102 by the corresponding PDU. As used with respect to cargo handling system 100, the term “beneath” may refer to the negative Z-direction, and the term “above” may refer to the positive Z-direction with respect to the conveyance surface 102. In the elevated position, the one or more drive rollers 108 variously contact and drive the ULD 120 that otherwise rides on the plurality of conveyance rollers 106. Other types of PDUs, which may also be used in various embodiments of the present disclosure, include a drive roller that is held or biased in a position above the conveyance surface by a spring. Without loss of generality, the PDUs as described herein may comprise any type of electrically powered rollers that may be selectively energized to propel or drive the ULD 120 in a desired direction over the cargo deck 112 of the aircraft. The plurality of trays 104 may further support a plurality of restraint devices 114. In various embodiments, each of the plurality of restraint devices 114 may be configured to rotate downward as the ULD 120 passes over and along the conveyance surface 102. Once the ULD 120 passes over any such one of the plurality of restraint devices 114, such restraint device returns to its upright position, either by a motor driven actuator or a bias member, thereby restraining or preventing the ULD 120 from translating in the opposite direction.

In various embodiments, the cargo handling system 100 may include a system controller 130 in communication with each of the plurality of PDUs 110 via a plurality of channels 132. Each of the plurality of channels 132 may be a data bus, such as, for example, a controller area network (CAN) bus. An operator may selectively control operation of the plurality of PDUs 110 using the system controller 130. In various embodiments, the system controller 130 may be configured to selectively activate or deactivate the plurality of PDUs 110. Thus, the cargo handling system 100 may receive operator input through the system controller 130 to control the plurality of PDUs 110 in order to manipulate movement of the ULD 120 over the conveyance surface 102 and into a desired position on the cargo deck 112. In various embodiments, the system controller 130 may include a general purpose processor, a digital signal processor (DSP), an application specific integrated circuit (ASIC), a field programmable gate array (FPGA) or some other programmable logic device, discrete gate or transistor logic, discrete hardware components, or any combination thereof. The cargo handling system 100 may also include a power source 126 configured to supply power to the plurality of PDUs 110 or to the plurality of restraint devices 114 via one or more power buses 128.

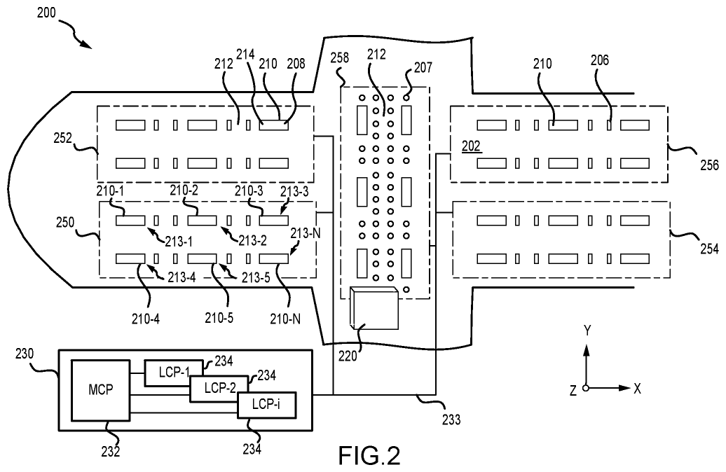

Referring now to FIG. 2, a schematic view of a cargo handling system 200 positioned on a cargo deck 212 of an aircraft is illustrated, in accordance with various embodiments. The cargo deck 212 may comprise a plurality of PDUs 210, generally arranged in a matrix configuration about the cargo deck 212. Associated with each of the plurality of PDUs 210 may be one or more drive rollers 208 and a restraint device 214. In various embodiments, the plurality of PDUs 210, the one or more drive rollers 208 and the restraint device 214 share similar characteristics and modes of operation as the plurality of PDUs 110, the one or more drive rollers 108 and the plurality of restraint devices 114 described above with reference to FIG. 1B. Each of the one or more drive rollers 208 is generally configured to selectively protrude from a conveyance surface 202 of the cargo deck 212 in order to engage with a surface of a ULD 220 as it is guided onto and over the conveyance surface 202 during loading and unloading operations. A plurality of conveyance rollers 206 may be arranged among the plurality of PDUs 210 in a matrix configuration as well. The plurality of conveyance rollers 206 may comprise passive elements, and may include roller ball units 207 that serve as stabilizing and guiding apparatus for the ULD 220 as it is conveyed over the conveyance surface 202 by the plurality of PDUs 210.

In various embodiments, the cargo handling system 200 or, more particularly, the conveyance surface 202, is divided into a plurality of sections. As illustrated, for example, the conveyance surface 202 may include a port-side track and a starboard-side track along which a plurality of ULDs may be stowed in parallel columns during flight. Further, the conveyance surface 202 may be divided into an aft section and a forward section. Thus, the port-side and the starboard-side tracks, in various embodiments and as illustrated, may be divided into four sections—e.g., a forward port-side section 250, a forward starboard-side section 252, an aft port-side section 254 and an aft starboard-side section 256. The conveyance surface 202 may also have a lateral section 258, which may be used to transport the ULD 220 onto and off of the conveyance surface 202 as well as transfer the ULD 220 between the port-side and starboard-side tracks and between the aft section and the forward section. The configurations described above and illustrated in FIG. 2 are exemplary only and may be varied depending on the context, including the numbers of the various components used to convey the ULD 220 over the conveyance surface 202. In various embodiments, for example, configurations having three or more track configurations, rather than the two-track configuration illustrated in FIG. 2, may be employed.

Each of the aforementioned sections—i.e., the forward port-side section 250, the forward starboard-side section 252, the aft port-side section 254 and the aft starboard-side section 256—may include one or more of the plurality of PDUs 210. Each one of the plurality of PDUs 210 has a physical location on the conveyance surface 202 that corresponds to a logical address within the cargo handling system 200. For purposes of illustration, the forward port-side section 250 is shown having a first PDU 210-1, a second PDU 210-2, a third PDU 210-3, a fourth PDU 210-4, a fifth PDU 210-5 and an N-th PDU 210-N. The aforementioned individual PDUs are located, respectively, at a first location 213-1, a second location 213-2, a third location 213-3, a fourth location 213-4, a fifth location 213-5 and an N-th location 203-N. In various embodiments, the each of the aforementioned individual PDUs on the conveyance surface 202 may have a unique location (or address) identifier, which, in various embodiments, may be stored in an RFID device or a similar device associated with each individual PDU.

In various embodiments, an operator may control operation of the plurality of PDUs 210 using one or more control interfaces of a system controller 230, such as, for example, the system controller 130 described above with reference to FIG. 1B. For example, an operator may selectively control the operation of the plurality of PDUs 210 through an interface, such as, for example, a master control panel 232 (MCP). In various embodiments, the cargo handling system 200 may also include one or more local control panels 234 (LCP). In various embodiments, the master control panel 232 may communicate with the local control panels 234. The master control panel 232 or the local control panels 234 may also be configured to communicate with or send or receive control signals or command signals to or from each of the plurality of PDUs 210 or to a subset of the plurality of PDUs 210, such as, for example, the aforementioned individual PDUs described above with reference to the forward port-side section 250. For example, a first local control panel LCP-1 may be configured to communicate with the PDUs residing in the forward port-side section 250, a second local control panel LCP-2 may be configured to communicate with the PDUs residing in the forward starboard-side section 252, and one or more additional local control panels LCP-i may be in communication with the PDUs of one or more of the aft port-side section 254, the aft starboard-side section 256 and the lateral section 258. Thus, the master control panel 232 or the local control panels 234 may be configured to allow an operator to selectively engage or activate one or more of the plurality of PDUs 210 to propel the ULD 220 along conveyance surface 202.

In various embodiments, each of the plurality of PDUs 210 may be configured to receive a command from the master control panel 232 or one or more of the local control panels 234. In various embodiments, the commands may be sent or information exchanged over a channel 233, which may provide a communication link between the system controller 230 and each of the plurality of PDUs 210. In various embodiments, a command signal sent from the system controller 230 may include one or more logical addresses, each of which may correspond to a physical location of one of the plurality of PDUs 210. Each of the plurality of PDUs 210 that receives the command signal may determine if the command signal is intended for that particular PDU by comparing its own address to the address included in the command signal.

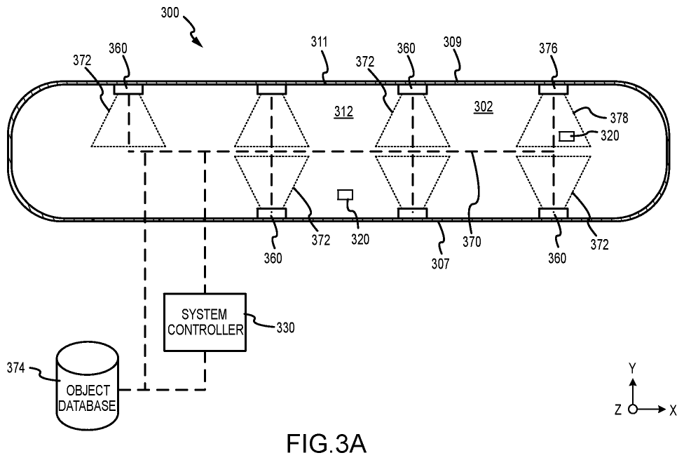

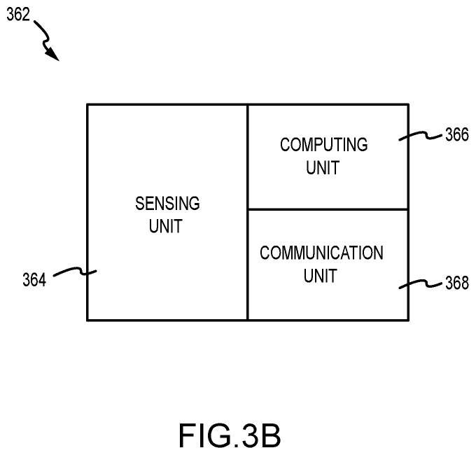

Referring now to FIGS. 3A and 3B, a schematic view of a cargo handling system 300 positioned on a cargo deck 312 of an aircraft is illustrated, in accordance with various embodiments. As described in further detail below, the cargo handling system 300 is an autonomous cargo handling system configured to perform several operations, such as, for example, monitor and gather data, estimate current situations or scenarios in the cargo hold, control movement of cargo (e.g., a ULD or a pallet) and provide warnings when a potential for problems or anomalies (e.g., collisions) arise during a cargo loading or unloading process. For example, in various embodiments, the cargo handling system 300 may, among other things, monitor and gather data about the cargo loading or unloading process to more accurately control the movement of a ULD 320 (or a plurality of ULDs) over a conveyance surface 302; assess and detect a potential for collisions of the ULD 320 with the walls of an aircraft (e.g., a port-side wall 307 or a starboard-side wall 309, which together define, in part, an aircraft envelope 311) or other objects on the cargo deck 312; detect the presence of human operators on the cargo deck 312; monitor each of a plurality of PDUs (e.g., the plurality of PDUs 210 described above with reference to FIG. 2) incorporated into the cargo deck 312; predict a current dynamic model of the plurality of PDUs; or perform various other operations, as discussed herein. In this regard, and in accordance with various embodiments, the cargo handling system 300 may provide information about the status of each ULD on the cargo deck 312 or each PDU incorporated into the cargo deck 312, as well as information regarding the presence of human operators or other objects on the cargo deck 312, in order to control the movement of a plurality of ULDs through the cargo deck 312 with a greater level of autonomy and safety and at a lower cost than cargo systems requiring greater human interaction.

With continued reference to FIGS. 3A and 3B, the cargo handling system 300 comprises a plurality of sensing agents 360 (e.g., a first sensing agent, a second sensing agent . . . and an Nth sensing agent). Each of the plurality of sensing agents 360 may be configured to monitor and gather data during the cargo loading or unloading process and during transportation of the cargo. The plurality of sensing agents 360 may be located in any suitable location on cargo deck 312 capable of monitoring the cargo loading process. For example, and in various embodiments, one or more of the plurality of sensing agents 360 may be coupled to an inner surface of the aircraft envelope 311, a ceiling within the aircraft or at any other suitable location. The plurality of sensing agents 360 may be located at any suitable elevation within the aircraft envelope 311, such as, for example, at a midpoint between the aircraft ceiling and the cargo deck 312. The plurality of sensing agents 360 may be stationary or may be configured to rotate or translate within the aircraft envelope 311 and with respect to the XYZ coordinate system. The plurality of sensing agents 360 may be dispersed throughout the aircraft envelope 311 to completely monitor a loading or unloading process and to establish a distributed network of sensing agents. Each of the plurality of sensing agents 360 may comprise any suitable apparatus capable of monitoring and gathering data during the loading or unloading process. For example, each of the plurality of sensing agents 360 may be computer based, comprising a processor, a tangible non-transitory computer-readable memory and a network interface, along with other suitable system software or hardware components. Instructions stored on the tangible non-transitory computer-readable memory enable the plurality of sensing agents 360 to perform various functions, as described herein.

In various embodiments, one or more of the plurality of sensing agents 360 may also comprise various sub-components to aid in monitoring and gathering data during operation of the cargo deck 312. For example, and with reference to FIG. 3B, one of the plurality of sensing agents 360 (e.g., a sensing agent 362) may comprise one or more of a sensing unit 364, a computing unit 366 and a communication unit 368. The sensing unit 364, the computing unit 366 and the communication unit 368 may be in operative or electronic communication with each other. As discussed further herein, the computing unit 366 may include logic configured to control the sensing unit 364 and the communication unit 368. In various embodiments, each one or more of the plurality of sensing agents 360 may also comprise any other suitable or desirable sub-component, such as, for example, an actuation component configured to provide an actuating force to one or more of the plurality of PDUs within the cargo deck 312. In that respect the computing unit 366, via the communication unit 368 or via direct control of the actuation component, may variably control the one or more of the plurality of PDUs.

In various embodiments, the sensing unit 364 may comprise any suitable apparatus, hardware or software capable of monitoring a portion of the cargo deck 312. Further, sensing unit 364 may comprise a plurality of devices, including, for example, one or more of a camera, a structured light sensor, a light detection and ranging (LiDAR) sensor, an infrared sensor, a depth sensor (e.g., a MICROSOFT® Kinect®, a MYNT® Eye, or an ASUS® Xtion PRO), a three-dimensional scanner, an ultrasound range finder, a radar sensor or any other suitable sensing device. The sensing unit 364 may also comprise a sensor configured to measure a weight of an object (e.g., a weight sensor), such as, for example, a pressure sensor or a piezo-electric sensor or the like.

In various embodiments, the computing unit 366 may comprise any suitable computing device capable of controlling the sensing agent 362. For example, the computing unit 366 may include a processor and a tangible, non-transitory memory. The computing unit 366 may comprise one or more logic modules that implement logic to control the sensing unit 364 or the communication unit 368. The computing unit 366 may include a general purpose processor, a digital signal processor (DSP), an application specific integrated circuit (ASIC), a field programmable gate array (FPGA) or other programmable logic device, discrete gate or transistor logic, a graphics processing unit (GPU), discrete hardware components, or any combination thereof. In various embodiments, use of the computing unit 366 in each one of the plurality of sensing agents 360 may allow each sensing agent to perform processing operations locally (e.g., in a decentralized manner), thereby at least partially reducing the bandwidth requirements relative to a central processing system (e.g., transmitting high bandwidth data, such as a video feed, to a central processing location). In various embodiments, the processing operations performed by the computing unit 366 include reasoning tasks, such as, for example, sensor fusion, analysis of a current situation (or a situational awareness) in the cargo hold based on fused sensor data and predictions of futures states (e.g., collisions).

In various embodiments, the communication unit 368 may comprise any suitable communications interface. The communication unit 368 enables data to be transferred among the plurality of sensing agents 360. The communication unit 368, for example, may include a modem, a network interface (e.g., an Ethernet card), a communications port, a Personal Computer Memory Card International Association (PCMCIA) slot and card or the like. Data transferred via the communication unit 368 may be in the form of electronic, electromagnetic or optical signals, or other signals capable of being transmitted and received by the communication unit 368. These signals are provided to the communication unit 368 via a communications path or a network 370. The network 370 is configured to transmit the signals and may be implemented using a wire, a cable, a fiber optic line, a telephone line, a cellular link, a radio frequency (RF) link, a wireless link or other communication channel. In such manner, the network 370 may interconnect each of the plurality of sensing agents 360, via the communication unit 368 corresponding to individual sensing agents.

In various embodiments, and with continued reference to FIGS. 3A and 3B, the cargo handling system 300 may comprise a system controller 330 in operative or electronic communication with an object database 374. The system controller 330 may also be in operative or electronic communication with each of the plurality of sensing agents 360 via the network 370 and configured to control each of the plurality of sensing agents 360. The system controller 330 may include a general purpose processor, a digital signal processor (DSP), an application specific integrated circuit (ASIC), a field programmable gate array (FPGA) or other programmable logic device, discrete gate or transistor logic, discrete hardware components, or any combination thereof, and may also include a tangible, non-transitory memory. Similar to the system controller 130 described above with reference to FIG. 1B and the system controller 230 described above with reference to FIG. 2, the system controller 330 may also be in operative or electronic communication with a plurality of PDUs (e.g., the plurality of PDUs 210 described above with reference to FIG. 2). In such respect, the system controller 330 may be configured to control the plurality of PDUs based on the monitoring performed by the plurality of sensing agents 360 (e.g., based on the object property, the object model, etc.). In various embodiments, each of the plurality of sensing agents 360 may also be in operative or electronic communication with the object database 374, such that each of the plurality of sensing agents 360 may interact with the object database 374 without first interfacing with the system controller 330.

In various embodiments, the object database 374 comprises a suitable data structure, such as, for example, a database (including a relational, hierarchical, graphical, blockchain, or object-oriented structure or any other database configuration) or a flat file structure. The object database 374 may be configured to store and maintain data relating to the cargo handling system 300. For example, the object database 374 may store and maintain models comprising data of known object properties for various models of ULDs. The object database 374 may also store generated object models. In accordance with various embodiments, the object database 374 may store any other suitable data related to the cargo handling system 300, such as, for example, a health status of the cargo handling system 300 (e.g., information concerning the operability of each of the plurality of sensing agents 360 or the plurality of PDUs), the location of each known object or ULD, the location of each non-ULD, cargo properties, information concerning the cargo deck 312 (e.g., the state of one or more of a plurality of restraint devices, such as, for example, the plurality of restraint devices 114 described above with reference to FIG. 1B) or any other suitable data corresponding to a cargo handling system.

In various embodiments, and with continued reference to FIGS. 3A and 3B, the plurality of sensing agents 360 may be configured to perform one or more tasks during the cargo loading or unloading process. For example, the plurality of sensing agents 360 may be configured to perform a ULD localization task, a non-ULD detection task or a ULD modeling task. During the ULD localization task, each of the plurality of sensing agents 360 may monitor a sensing zone 372 (corresponding to each of the plurality of sensing agents 360) to locate and generate data on objects within the sensing zone 372. For example, a first sensing agent 376 transmits data concerning any objects (both ULD and non-ULD) within a first sensing zone 378 to the system controller 330 for analysis and determination of the identity and location of any ULDs within the first sensing zone 378. During the non-ULD detection task, the system controller 330 analyzes the data transmitted during the ULD localization task to determine whether an object within the first sensing zone 378 is not a ULD and, if not, what the object is (e.g., a human operator). During the ULD modeling task, the system controller 330 compares the data transmitted by the plurality of sensing agents 360 and analyzes the data for consistency, accuracy or quality. Discrepancies among the data may then be used to detect or identify internal faults that may exist with a particular sensing agent (e.g., a malfunctioning or occluded sensor unit, a faulty communication unit, a local power outage, a hardware or mechanical failure, or an incorrect positioning of a sensing agent). In various embodiments, the plurality of sensing agents 360 may also be configured to transmit data used to perform various other tasks during the cargo loading or unloading process, such as, for example, controlling the motion of a ULD, prognostics and health management of the cargo handling system 300, weight and balance assessment of a ULD, or any other suitable or desired task.

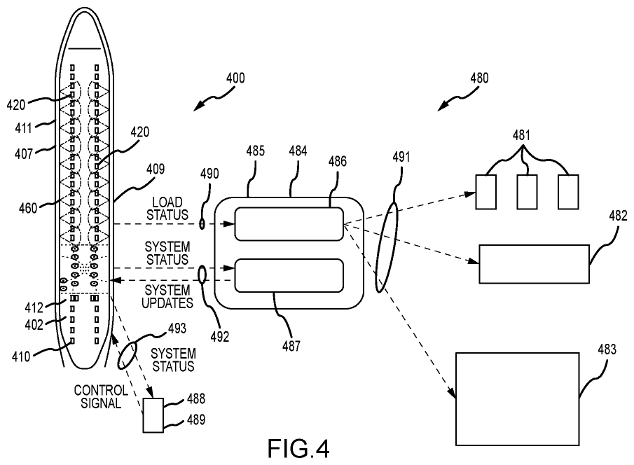

Referring now to FIG. 4, a communication network 480 is illustrated in operable connection with a cargo handling system 400 configured for autonomous operation. Similar to the cargo handling system 300 described above with reference to FIGS. 3A and 3B, the cargo handling system 400 is positioned on a cargo deck 412 of an aircraft. In various embodiments, the cargo handling system 400 may, among other things, monitor and gather data about the cargo loading or unloading process to more accurately control the movement of a ULD 420 (or a plurality of ULDs) over a conveyance surface 402; assess and detect a potential for collisions of the ULD 420 with the walls of an aircraft (e.g., a port-side wall 407 or a starboard-side wall 409, which together define, in part, an aircraft envelope 411) or other objects on the cargo deck 412; detect the presence of human operators on the cargo deck 412; monitor each of a plurality of PDUs 410 (e.g., the plurality of PDUs 210 described above with reference to FIG. 2) incorporated into the cargo deck 412; predict a current dynamic model of the plurality of PDUs; or perform various other operations, as discussed herein. In this regard, and in accordance with various embodiments, the cargo handling system 400 may provide information about the status of each ULD on the cargo deck 412 or each of the plurality of PDUs 410 incorporated into the cargo deck 412, as well as information regarding the presence of human operators or other objects on the cargo deck 412, in order to control the movement of a plurality of ULDs through the cargo deck 412 with a greater level of autonomy and safety and at a lower cost than cargo systems requiring greater human interaction. The cargo handling system 400 comprises a plurality of sensing agents 460 (e.g., a first sensing agent, a second sensing agent . . . and an Nth sensing agent) configured to monitor and gather data during a cargo loading or unloading process and during transportation of the cargo. The plurality of sensing agents 460, including the positioning, operation and construction of each sensing agent within the plurality of sensing agents 460, is similar to the plurality of sensing agents 360 described above with reference to FIGS. 3A and 3B. Accordingly, details concerning such positioning, operation and construction are not repeated here.

Still referring to FIG. 4, the communication network 480 comprises a constellation of components or entities configured to provide real-time information about the status of one or more of the cargo handling system 400 or the cargo on the cargo handling system 400, either during loading or unloading or during transport via the aircraft. For example, in various embodiments, real-time information concerning load status (e.g., the status of a cargo or the contents of one or more of a plurality of ULDs) may be communicated via the communication network 480 to an end user or third party, such as, for example, an owner 481 of the cargo, an airport 482 that is included within a transportation route or an airline 483 that owns or operates the aircraft. By way of non-limiting example, the real-time information concerning load status may include information relating to temperature, pressure or humidity within the aircraft envelope 411 or within a particular ULD. The information may also include the location of a particular ULD within the aircraft envelope 411 during transportation, together with the dimension or weight of the particular ULD. In addition to real-time information, historical information may be communicated to the end user or third party. The historical information may include, for example, a history of the path a particular ULD traversed across the cargo deck 412 during a loading or unloading operation or a history, the velocity at which the particular ULD was transported across the cargo deck 412 or the accelerations experienced by the particular ULD (or the cargo or contents within the ULD) during loading, unloading or in-flight transportation. The historical information may also include a history of each of the examples of real-time information provided above.

In various embodiments, real-time information concerning system status (e.g., the status of the cargo handling system 400) may be communicated via the communication network 480 to an end user or third party, such as, for example, the owner or operator of the cargo handling system 400. By way of non-limiting example, the real-time information concerning system status may include information concerning operability (or lack thereof) of individual components comprising the cargo handling system 400. Such component may include, for example, operability of one or more of the plurality of sensing agents 460, one or more of the plurality of PDUs 410 or one or more of a plurality of restraint devices, such as, for example, the plurality of restraint devices 114 described above with reference to FIG. 1B. In various embodiments, one or more of the plurality of sensing agents 460 may become faulty due to dirt or other debris collecting on a lens for visual sensing or by failure of another sensing component (e.g., one or more of the sensing unit 364, the computing unit 366 or the communication unit 368 described above with reference to FIG. 3B). One or more of the plurality of PDUs 410 may become faulty through wear of the frictional surface (e.g., the rubber wheels comprising one or more of the drive rollers 108 described above with reference to FIG. 1B) used to transport the ULDs or through failure of the motor used to rotate the drive roller. The real-time information may also include an electrical power failure to one or more of the components comprising the cargo handling system 400 or failures of the system controller or the object database (e.g., the system controller 330 or the object database 374 described above with reference to FIG. 3A) that are used to control and operate the cargo handling system 400 during loading and unloading operations.

In various embodiments, the communication network 480 may include a central entity 484 positioned between the cargo handling system 400 and one or more of the owner 481 of the cargo, the airport 482 that is included within a transportation route or the airline 483 that owns or operates the aircraft. The central entity 484 may comprise a processor 485 (or a plurality of processors) that is owned or operated, for example, by the owner or operator of the cargo handling system 400. In various embodiments, the processor 485 is configured with a data analytics module 486 (or a first processor) configured to receive and process the real-time information concerning load status from the plurality of sensing agents 460. For example, the data analytics module 486 may receive imaging data from the plurality of sensing agents 460 and convert the imaging data into a physical location or condition (e.g., damage analysis) of a particular ULD within the cargo handling system 400 based on a request from the owner 481 of the cargo within the ULD or the airport 482 or the airline 483.

In various embodiments, the processor 485 also includes a system development module 487 (or a second processor) configured to receive and process the real-time information concerning system status (or system status data). For example, the system development module 487 may receive data from the plurality of sensing agents 460 (e.g., visual, temperature, pressure or humidity data), the plurality of PDUs 410 or the plurality of restraint devices and convert the data into operational status information of the various components of the cargo handling system 400 based on a request from the owner or operator of the cargo handling system 400. In various embodiments, the system development module 487 is also configured to provide a system update or software updates to the various components within the cargo handling system 400. In various embodiments, the first processor and the second processor comprise separate processors positioned at separate locations, comprise separate processors located at the same location (e.g., within the central entity 484) or comprise the same processor.

In various embodiments, the communication network 480 may include an auxiliary control unit 488 that includes a processor 489 in communication with a system controller within the cargo handling system 400 (e.g., the system controller 330 described above with reference to FIG. 3A). The auxiliary control unit 488 may be configured to receive and process the real-time information concerning system status and to direct control signals or commands to the cargo handling system 400 in response to the real-time information. In various embodiments, the auxiliary control unit 488 is configured to override the system controller and disable the cargo handling system 400 from being operated autonomously, thereby providing control to a human operator with visual or physical oversight of any aspect of the loading or unloading operation.

In various embodiments, the processor 485 (or the data analytics module 486) receives the real-time or historical information concerning load status over a first communication link 490 in the form of a first load status data (e.g., raw data). The first load status data is analyzed by the processor 485 (or by the data analytics module 486) to generate a second load status data (e.g., analyzed raw data). The second load status data (which, in various embodiments, may be identical to the first load status data) is then transmitted to an end used or third party, such as, for example, the owner 481 of the cargo, the airport 482 that is included within a transportation route or the airline 483 that owns or operates the aircraft over a second communication link 491. In various embodiments, the first load status data and the second load status data enable a visual representation of the cargo load or one or more of a pressure measurement, a temperature measurement or a humidity measurement, or representations thereof, be received by or provided to the end user or the third party. In various embodiments, the processor 485 (or the system development module 487) receives the real-time or historical information concerning system status over a third communication link 492 in the form of a system status data. The system status data is analyzed by the processor 485 (or by the system development module 487) to determine operability of the cargo handling system 400, including any faults or failures within the cargo handling system 400. In various embodiments, the processor 485 (or the system development module 487) is configured to generate a system status signal or alarm or report that indicates a fault or failed component within the cargo handling system 400 in an event of such fault or failure occurring. In various embodiments, the auxiliary control unit 488 is configured to transmit a control signal to the cargo handling system over a fourth communication link 493 and to receive the system status data over the fourth communication link 493.

In various embodiments, the communication network 480 is characterized as a multi-level communication network that enables information exchange at various levels while ensuring safety and security of the cargo handling system 400 and the cargo being transported. The various levels include a local level, where devices such as the auxiliary control unit 488 may connect to the cargo handling system 400 (or a system controller within the system) for purposes of control and operation of the cargo handling system 400. In various embodiments, security of the cargo handling system 400 is ensured by only allowing devices (e.g., the auxiliary control unit 488) owned or operated by the owner or operator of the cargo handling system 400 to connect to the system. The various levels also include a system level, where information concerning operability of the cargo handling system is either received from or transmitted to the cargo handling system 400. In various embodiments, the system level is limited to communication between the central entity 484 and the cargo handling system 400, thereby ensuring security of the cargo handling system 400. The various levels may also include an information level, where real-time information (or historical information) about the cargo being loaded, unloaded or transported may be communicated to third parties, such as, for example, the owner 481 of the cargo. In various embodiments, the third parties are provided access to the information via permission from the airline transporting the cargo, which may require payment of a fee. Unlike the local level and the system level, the information level is generally conveyed over a one-way link, thereby preventing third parties from gaining access to the cargo handling system 400 or the central entity 484 and compromising security of the cargo handling system 400 or the communication network 480.

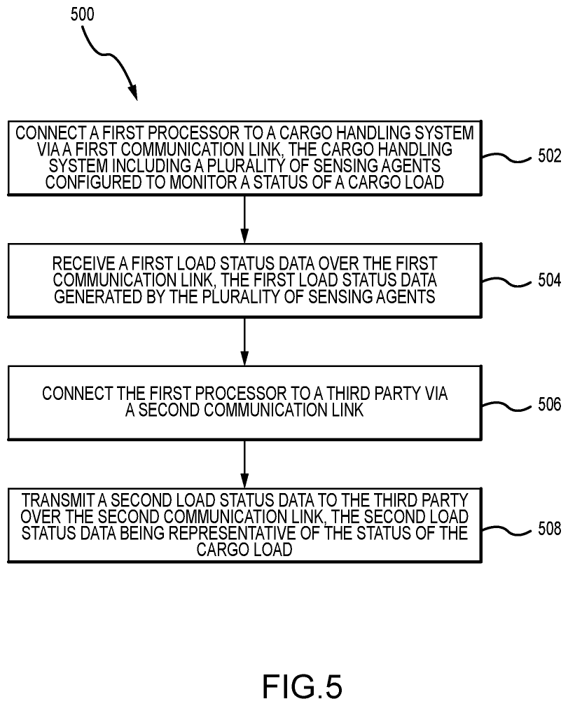

Referring now to FIG. 5, a method 500 of communicating information between a cargo handling system and a third party is described as having the following steps, without preference in any particular order of performing the steps. A first step 502 includes connecting a first processor to the cargo handling system via a first communication link, the cargo handling system including a plurality of sensing agents configured to monitor a status of a cargo load. A second step 504 includes receiving a first load status data over the first communication link, the first load status data generated by the plurality of sensing agents. A third step 506 includes connecting the first processor to the third party via a second communication link. A fourth step 508 includes transmitting a second load status data to the third party over the second communication link, the second load status data being representative of the status of the cargo load.

In various embodiments, the method 500 further includes analyzing the first load status data by the first processor to generate the second load status data, where the status of the cargo load is a visual representation of the cargo load. In various embodiments, the status of the cargo load represents one or more of a pressure measurement, a temperature measurement or a humidity measurement within an aircraft envelope that surrounds the cargo load. In various embodiments, the method 500 includes one or more of connecting a second processor to the cargo handling system via a third communication link and receiving by the second processor a system status data from the cargo handling system, analyzing the system status data and generating a system status signal in an event of a fault within the cargo handling system and transmitting a system update over the third communication link to the cargo handling system, transmitting a control signal over a fourth communication link to the cargo handling system from an auxiliary control unit and receiving the system status data over the fourth communication link.

In various embodiments, components, modules, or engines of the systems or apparatus described herein may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® operating system, and the like. The micro-app may be configured to leverage the resources of a larger operating system and associated hardware via a set of predetermined rules that govern the operation of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system that monitors various hardware components and then communicates a detected input from the hardware to the micro-app.

The system and methods described herein may also be described in terms of functional block components, screen shots, optional selections, and various processing steps. It should be appreciated that such functional blocks may be realized by any number of hardware or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® Active Server Pages, assembly, PERL®, PHP, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

The various system components discussed herein may also include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; or like data useful in the operation of the system. As those skilled in the art will appreciate, users computer may include an operating system (e.g., WINDOWS®, UNIX®, LINUX®, SOLARIS®, MACOS®, etc.) as well as various conventional support software and drivers typically associated with computers.

As used herein, the term “network” includes any cloud, cloud computing system, or electronic communications system or method that incorporates hardware or software components. Communication among the components of the systems may be accomplished through any suitable communication channels, such as, for example, a telephone network, an extranet, an intranet, or an internet. Such communications may also occur using online communications, satellite communications, off-line communications, wireless communications, transponder communications, local area network (LAN), wide area network (WAN), or virtual private network (VPN). Moreover, the systems may be implemented with TCP/IP communications protocols, IPX, APPLETALK®, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 10% of, within 5% of, within 1% of, within 0.1% of, and within 0.01% of a stated amount or value.

In various embodiments, system program instructions or controller instructions may be loaded onto a tangible, non-transitory, computer-readable medium (also referred to herein as a tangible, non-transitory, memory) having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media that were found by In Re Nuijten to fall outside the scope of patentable subject matter under 35 U.S.C. § 101.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed:

1. A communication network configured for connection with a cargo handling system and a third party, comprising:
a first processor;
a first communication link connecting the first processor to the cargo handling system, the cargo handling system including a plurality of sensing agents configured to monitor a status of a cargo load; and
a second communication link connecting the first processor to the third party;
wherein the first processor is configured to receive a first load status data from the cargo handling system over the first communication link and to transmit a second load status data to the third party over the second communication link.

2. The communication network of claim 1, wherein the first processor is configured to analyze the first load status data and to generate the second load status data.

3. The communication network of claim 2, wherein the second load status data is representative of the status of the cargo load.

4. The communication network of claim 3, wherein the status of the cargo load is a visual representation of the cargo load.

5. The communication network of claim 3, wherein the status of the cargo load represents one or more of a pressure measurement, a temperature measurement or a humidity measurement within an aircraft envelope that surrounds the cargo load.

6. The communication network of claim 1, further comprising a second processor and a third communication link connecting the second processor to the cargo handling system, the second processor configured to receive a system status data from the cargo handling system.

7. The communication network of claim 6, wherein the second processor is configured to analyze the system status data and to generate a system status signal that indicates a fault within the cargo handling system.

8. The communication network of claim 7, wherein the second processor is configured to transmit a system update to the cargo handling system.

9. The communication network of claim 8, wherein the second processor is configured to transmit the system update to the cargo handling system over the third communication link.

10. The communication network of claim 6, further comprising a fourth communication link configured to transmit control signals to the cargo handling system from an auxiliary control unit.

11. The communication network of claim 10, wherein the auxiliary control unit is configured to receive the system status data over the fourth communication link.

12. The communication network of claim 10, wherein the auxiliary control unit is configured to override a system controller configured to operate the cargo handling system.

13. A method of communicating information between a cargo handling system and a third party, comprising:
connecting a first processor to the cargo handling system via a first communication link, the cargo handling system including a plurality of sensing agents configured to monitor a status of a cargo load;
receiving a first load status data over the first communication link, the first load status data generated by the plurality of sensing agents;
connecting the first processor to the third party via a second communication link; and
transmitting a second load status data to the third party over the second communication link, the second load status data being representative of the status of the cargo load.

14. The method of claim 13, further comprising analyzing the first load status data by the first processor to generate the second load status data.

15. The method of claim 14, wherein the status of the cargo load is a visual representation of the cargo load.

16. The method of claim 14, wherein the status of the cargo load represents one or more of a pressure measurement, a temperature measurement or a humidity measurement within an aircraft envelope that surrounds the cargo load.

17. The method of claim 13, further comprising connecting a second processor to the cargo handling system via a third communication link and receiving by the second processor a system status data from the cargo handling system.

18. The method of claim 17, further comprising analyzing the system status data and generating a system status signal in an event of a fault within the cargo handling system.

19. The method of claim 17, further comprising transmitting a system update over the third communication link to the cargo handling system.

20. The method of claim 17, further comprising transmitting a control signal over a fourth communication link to the cargo handling system from an auxiliary control unit and receiving the system status data over the fourth communication link.
